(19) United States
(12) Patent Application Publication
(10) Pub. No.: US 2014/0329521 A1
(43) Pub. Date: Nov. 6, 2014

(54) APPARATUS, SYSTEM, AND METHOD FOR ENABLING COMMUNICATION AMONG A PLURALITY OF DIFFERENT COMMUNICATION DEVICES

(71) Applicants: Gerard J. Stauder, St. Peters, MO (US); Neil T. Birchler, St. Peters, MO (US); Paul J. Davey, St. Peters, MO (US); John F. Gabler, St. Peters, MO (US); Greg B. Lorenz, St. Peters, MO (US)

(72) Inventors: Gerard J. Stauder, St. Peters, MO (US); Neil T. Birchler, St. Peters, MO (US); Paul J. Davey, St. Peters, MO (US); John F. Gabler, St. Peters, MO (US); Greg B. Lorenz, St. Peters, MO (US)

(73) Assignee: Stauder Consulting, Inc., St. Peters, MO (US)

(21) Appl. No.: 13/597,998

(22) Filed: Aug. 29, 2012

(51) Int. Cl. H04W 80/00; H04W 24/04; H04W 4/02

(52) U.S. Cl. CPC H04W 80/00; H04W 4/02; H04W 24/04; H04W 88/06
USPC 455/426.1; 455/552.1

(57) ABSTRACT

An apparatus for enabling communication among a plurality of different communication devices is provided. Additionally, a system for enabling communication among a plurality of different communication devices is provided. Further, a method for enabling communication among a plurality of different communication devices using an apparatus is provided.

### BACKGROUND OF THE INVENTION

The field of the invention relates generally to communication and more specifically to enabling communication among devices that communicate with different protocols.

A wide array of systems across varying industries include as at least a portion of their functionality, the ability to send and receive information among the components of each system. For example, systems that employ sensors in a home security, home automation, or factory automation environment generally communicate measurements, status updates, or alarm conditions to at least one other component in order to coordinate the operation of the system. Often such systems are installed permanently or semi-permanently within a facility and are built to operate reliably for many decades. Other such systems are installed not in buildings, but in ground-based vehicles, aircraft, spacecraft, or ships.

Systems as described above are generally designed for a particular purpose and, while communication among the components may be one function of the systems, it is not always central to their operation. Accordingly, extensibility of the functionality of the systems through interoperability with unrelated systems is often not a high priority in the design of such systems. In other instances, even if interoperability with other systems is a priority, meeting this design goal is limited by what is known about the functionality, and particularly the communication hardware, methods, standards, or protocols used by existing or planned systems of the time. Of course, many such systems that are in operation now were made decades ago and, given the investments associated with them, are not likely to be replaced until they stop working. Accordingly, many decades-old systems remain locked within their legacy communication protocols, unable to communicate with other systems.

### BRIEF DESCRIPTION OF THE INVENTION

In one aspect, an apparatus for enabling communication among a plurality of different communication devices is provided. The apparatus includes a processor and a memory coupled to the processor. The memory contains processor-executable instructions for communicating using a plurality of different protocols, selecting a first protocol from the plurality of different protocols to communicate with a first communication device, selecting a second protocol from the plurality of different protocols to communicate with a second communication device, receiving a first message from the first communication device using the first protocol, and transmitting the first message to the second communication device using the second protocol.

In another aspect, a system for enabling communication among a plurality of communication devices is provided. The system includes a first communication device configured to communicate using a first protocol and a second communication device configured to communicate using a second protocol. The system also includes a third communication device configured to communicate using a third protocol. The system also includes a fourth communication device configured to communicate using a fourth protocol. The system also includes a fifth communication device configured to communicate using a fifth protocol. The system also includes a sixth communication device configured to communicate using a sixth protocol. The system also includes and a seventh communication device configured to communicate using a seventh protocol.

The above-described system also includes a first apparatus communicatively coupled to the first communication device and the second communication device. The first apparatus is configured to translate between the first protocol and the second protocol. The system also includes a second apparatus communicatively coupled to the third communication device, the fourth communication device, and the fifth communication device. The second apparatus is configured to translate between the third protocol and the fourth protocol and between the fourth protocol and the fifth protocol. The system also includes a third apparatus communicatively coupled to the sixth communication device and the seventh communication device. The third apparatus is configured to translate between the sixth protocol and the seventh protocol. The first communication device is configured to transmit a first message to the first apparatus. The first apparatus is configured to transmit the first message to the second communication device. The second communication device is configured to transmit the first message to the third communication device. The third communication device is configured to transmit the first message to the second apparatus. The second apparatus is configured to transmit the first message to said fourth communication device. The fourth communication device is configured to transmit a second message to the second apparatus. The second apparatus is configured to transmit the second message to the fifth communication device. The fifth communication device is configured to transmit the second message to the sixth communication device. The sixth communication device is configured to transmit the second message to the third apparatus. The third apparatus is configured to transmit the second message to the seventh communication device.

In another aspect, a method for enabling communication among a plurality of different communication devices using an apparatus is provided. The apparatus has a processor coupled to a memory containing processor-executable instructions for communicating using a plurality of protocols. The method includes selecting a first protocol from the plurality of different protocols to communicate with a first communication device, selecting a second protocol from the plurality of different protocols to communicate with a second communication device, receiving a first message from the first communication device using the first protocol, and transmitting the first message to the second communication device using the second protocol.

### BRIEF DESCRIPTION OF THE DRAWINGS

FIG. 1 is a perspective view of an apparatus in accordance with an exemplary embodiment of the present invention.

FIG. 2 is another perspective view of an apparatus in accordance with another exemplary embodiment of the present invention.

FIG. 3 is an internal block diagram of an apparatus in accordance with an exemplary embodiment of the present invention.

FIG. 4 is a diagram of a first system of apparatuses and communication devices in accordance with an exemplary embodiment of the present invention.

FIG. 5 is a diagram of a second system of apparatuses and communication devices in accordance with another embodiment of the present invention.

### DETAILED DESCRIPTION OF THE INVENTION

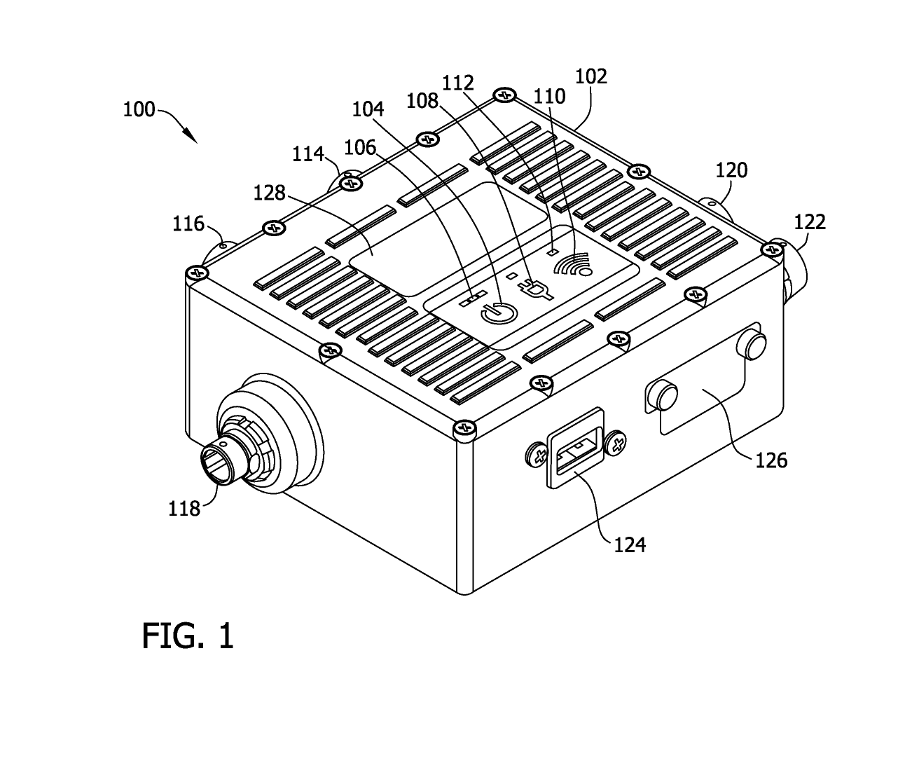

FIG. 1 is a perspective view of an apparatus 100 in accordance with an exemplary embodiment of the present invention. Apparatus 100 includes a housing 102. In exemplary embodiments, housing 102 is metal, waterproof, and capable of withstanding harsh environments. On/off button 104 may be pressed to switch apparatus 100 between an on state and an off state. In the exemplary embodiment, on/off button 104 may also be pressed to switch apparatus 100 into a standby mode and/or cause apparatus 100 to reset. Light-emitting diode (LED) group 106 indicates the status of apparatus 100, for example whether apparatus 100 is off, on, in standby mode, or resetting. Power LED 108 indicates whether apparatus 100 is receiving power from an external source, for example, power LED 108 may illuminate when apparatus 100 is plugged into an external power source. In addition, power LED 108 may blink to indicate that an internal battery is low on energy and that apparatus 100 should be connected to an external power source to continue operating and charge the battery. Wireless local area network (WLAN) button 110 activates and deactivates an internal WLAN radio in apparatus 100. WLAN LED 112 indicates the status of the internal WLAN radio. For example, if WLAN LED 112 is illuminated, the internal WLAN radio is activated. WLAN may communicate, for example, using an Institute of Electrical and Electronics Engineers (IEEE) 802.11 standard.

Apparatus 100 includes multiple communication interfaces, 114, 116, 118, 120, 122, 124, and 126. In the exemplary embodiment, communication interface 114 is configured to receive and/or send video data. In the exemplary embodiment, communication interface 114 is configured to send and/or receive video data pursuant to RS-170. Communication interface 116 is configured to send and/or receive data pursuant to RS-232. As known in the art, RS-232 is a name for a series of standards for serial binary single-ended data and control signals. Communication interface 118 is configured to communicate pursuant to IEEE 802.3, also known as Ethernet. Communication interface 120 is configured to communicate pursuant to MIL-STD-1553. Likewise, communication interface 122 is configured to communicate pursuant to MIL-STD-1553. As known in the art, MIL-STD-1553 is a military standard published by the United States Department of Defense that defines the mechanical, electrical, and functional characteristics of a serial data bus.

Communication interface 124 is configured to communicate pursuant to a Universal Serial Bus (USB) standard. Communication interface 126 is configured to communicate pursuant to one or more infrared communications protocols defined, for example, by the Infrared Data Association (IrDA). For example, such protocols include the infrared physical layer specification (IrPHY), infrared link access protocol (IrLAP), infrared link management protocol (IrLMP), tiny transport protocol (Tiny TP), infrared communications protocol (IrCOMM), object exchange (OBEX) protocol, infrared local area network (IrLAN), IrSimple, and IrSimpleShot. Housing 102 includes a non-metal panel 128, which enables the internal WLAN antenna (not shown) to obtain a stronger communication signal than if housing 102 was entirely made of metal. Non-metal panel 128 may include plastic or other dielectric materials. In alternative embodiments, a door or access panel where a memory card may be inserted is located in place of communication interface 126.

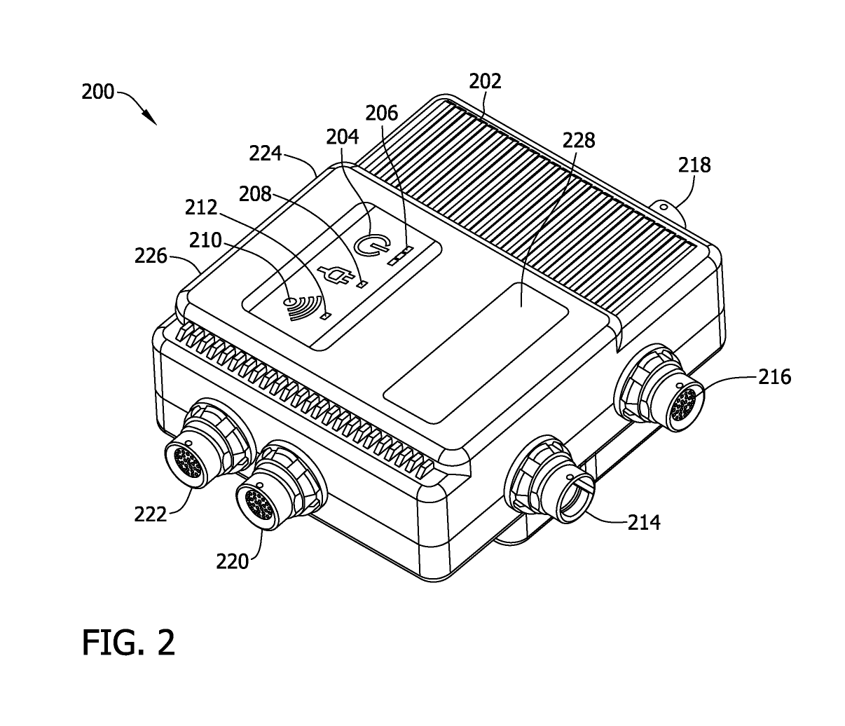

FIG. 2 is another perspective view of an apparatus 200 in accordance with another exemplary embodiment of the present invention. Housing 202 is smaller in volume than housing 102. However, much like exemplary embodiments of housing 102, exemplary embodiments of housing 202 are waterproof and otherwise able to withstand harsh conditions. Apparatus 200 includes on/off button 204 and on/off LED group 206. On/off button 204 and on/off LED group 206 operate in the same ways as on/off button 104 and on/off LED group 106 of FIG. 1. Apparatus 200 also includes a power LED 208, which operates in the same way as power LED 108, of FIG. 1. Further, apparatus 200 includes a WLAN button 210 and a WLAN LED 212, both of which operate in the same ways as WLAN button 110 and WLAN LED 112, respectively, of FIG. 1. Apparatus 200 additionally includes communication interfaces 214, 216, 218, 220, and 222, which are configured and operate in the same ways as communication interfaces 114, 116, 118, and 120 of FIG. 1.

Apparatus 200 additionally includes at least one additional communication interface 224 which is configured to communicate pursuant to a USB protocol, similar to communication interface 124 of FIG. 1. Further, apparatus 200 includes an additional communication interface 226, which is configured to communicate pursuant to an infrared communications protocol, similar to communication interface 126 of FIG. 1. Further, housing 202 includes a non-metal panel 228 to enable an internal WLAN antenna (not shown) in apparatus 200 to obtain a better communications signal than if housing 202 was entirely made of metal.

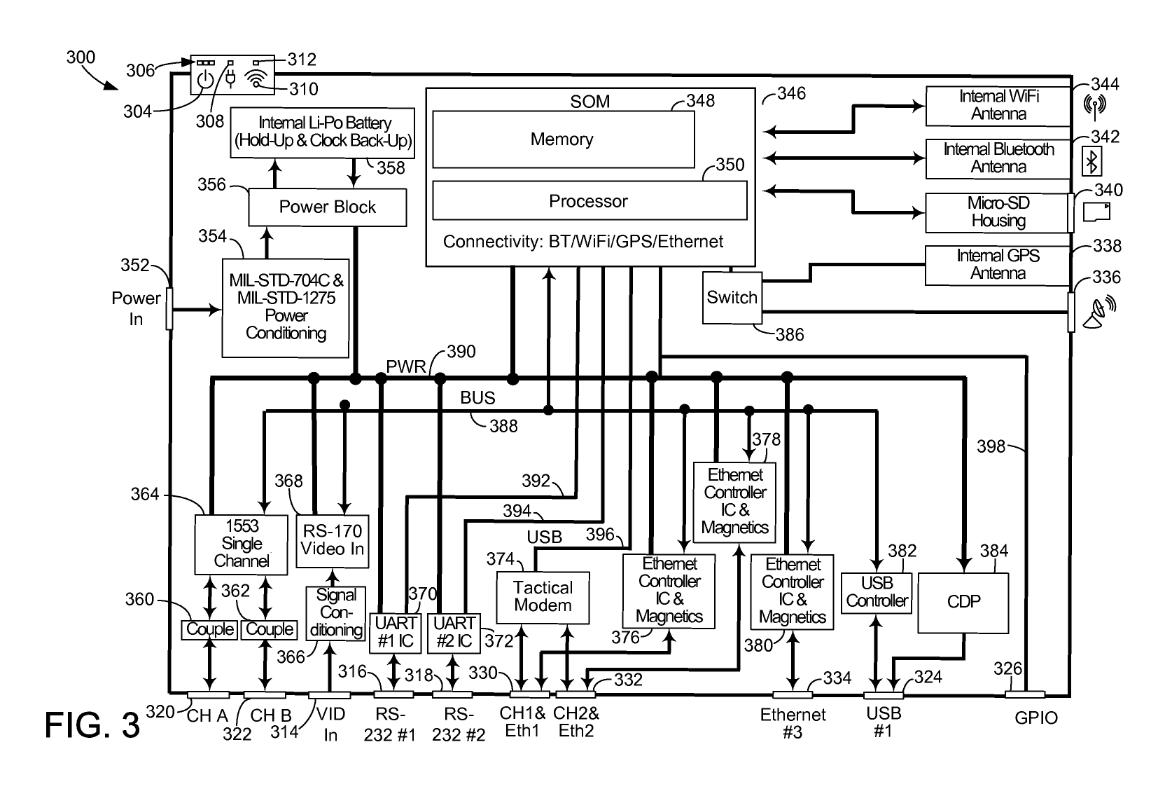

FIG. 3 is an internal block diagram of an apparatus 300 in accordance with an exemplary embodiment of the present invention. Apparatus 300 includes an on/off button 304, an on/off LED group 306, a power LED 308, a WLAN button 310, and a WLAN LED 312, which operate in the same ways as on/off button 104, on/off LED group 106, power LED 108, WLAN button 110, and WLAN LED 112, of FIG. 1. Apparatus 300 includes a communication interface 314 which is configured to receive video data. In alternative embodiments, communication interface 314 instead sends video data and in yet other embodiments, communication interface 314 both sends and receives video data. In FIG. 3, video data passes through communication interface 314 to a signal conditioner 366. Signal conditioner 366 then sends conditioned video data to a video controller 368, which is configured to receive the video data pursuant to the RS-170 protocol. Video controller 368 may convert analog video data to digital video data and/or convert the video data to a different encoding scheme or format. In alternative embodiments, system on module (SOM) 346 is configured to convert video data from one encoding scheme or format to another. SOM 346 is communicatively coupled to video controller 368 by bus 388.

Communication interface 316 is configured to send and receive data pursuant to RS-232. Data sent and received through communication interface 316 passes through universal asynchronous receiver/transmitter (UART) 370. SOM 346 is communicatively coupled to UART 370 by bus 392. Likewise, communication interface 318 is configured to send and receive data pursuant to RS-232. Data sent and received using communication interface 318 passes through UART 372. UART 372 is communicatively coupled to SOM 346 by bus 394. Communication interface 320 is communicatively coupled to 1553 controller 364 by couple 360. Likewise, communication interface 322 is communicatively coupled to single channel controller 364 by couple 362. Single channel controller 364 and communication interfaces 320 and 322 are configured to send and receive data pursuant to MIL-STD-1553. Single channel controller 364 is communicatively coupled to SOM 346 by bus 388.

Communication interface 324 is communicatively coupled to USB controller 382. USB controller 382 is communicatively coupled to SOM 346 by bus 388. Communication interface 324 is also coupled to charging downstream port (CDP) 384. Communication interface 326 is communicatively coupled to SOM 346 by bus 398. Communication interface 326 is controlled by processor-executable instructions stored in memory 348 on SOM 346, to be executed by processor 350 of SOM. Processor 350 is communicatively coupled to memory 348 of SOM 346. Given that communication interface 326 is controlled by processor-executable instructions, it is a general purpose input/output (GPIO) communication interface. Communication interface 330 is communicatively coupled to both tactical modem 374 and Ethernet controller 376. Communication interface 332 is communicatively coupled to tactical model 374 and Ethernet controller 378. Tactical modem 374 is communicatively coupled to SOM 346 by universal serial bus 396. Ethernet controllers 376 and 378 are communicatively coupled to SOM 346 by bus 388. Communication interface 334 is communicatively coupled to Ethernet controller 380, which in turn is communicatively coupled to SOM 346 by bus 388.

Communication interface 336 is configured to send and receive data from an external GPS antenna. Also included in apparatus 300 is internal GPS antenna 338. Switch 386 selects whether SOM 346 communicates with internal GPS antenna 338 or communicates using communication interface 336 to an external GPS antenna. For example, if an external GPS antenna is connected through communication interface 336, switch 386 may automatically route communications from SOM 346 through communication interface 336, rather than to internal GPS antenna 338. Alternatively, SOM 346 may be configured to cause switch 386 to select an external GPS antenna over internal GPS antenna 346, when SOM 346 detects that an external GPS antenna is connected to communication interface 336. Additionally, if SOM 346 detects that either internal GPS antenna 338 or an external GPS antenna connected through communication interface 336 is malfunctioning, SOM 346 may cause switch 386 to select the properly-functioning antenna for communication with SOM 346.

Apparatus 300 additionally includes an external memory interface 340. In the exemplary embodiment, external memory interface 340 includes a microSD interface, configured to receive a microSD memory card and store or retrieve data from the microSD memory card pursuant to instructions from SOM 346. MicroSD is a trademark of SD-3C, LLC of Wilmington, Del. SOM 346 is communicatively coupled to external memory interface 340. In other embodiments, external memory interface 340 is instead configured to store and retrieve data from a USB flash drive, a hard drive, an optical disk, or any other type of external memory storage device. In the exemplary embodiment, an external memory storage device includes processor executable instructions, for example, instructions for one or more communication protocols and/or for converting video from one format or encoding scheme to another. Additionally, an external memory storage device may contain data, such as map data. Such processor executable instructions and/or data may be retrieved by SOM 346 on an as-needed basis or copied into memory 348 of SOM 346 so that SOM 346 need not rely on the external memory storage device remaining interfaced with external memory interface 340.

Further included in apparatus 300 is communication interface 342. Communication interface 342 includes an internal wireless communication antenna and, in the exemplary embodiment, communication interface 342 is configured to communicate pursuant to the Bluetooth protocol. Bluetooth is a trademark of Bluetooth SIG, Inc. of Kirkland, Wash. In other embodiments, communication interface 342 may communicate pursuant to any other wired or wireless communication protocol. Apparatus 300 also includes communication interface 344. Communication interface 344 includes an internal wireless communication radio and is configured to communicate in a wireless local area network (WLAN) pursuant to an IEEE 802.11 communication protocol. The WLAN radio of communication interface 344 may be enabled or disabled by WLAN button 310. WLAN LED 312 indicates the status of the WLAN radio by illuminating when the WLAN radio is activated and darkening when the WLAN radio is deactivated. Both communication interface 342 and communication interface 344 are communicatively coupled to SOM 346.

In embodiments in accordance with the present invention, processor executable instructions for communicating using the various protocols employed by communication interfaces 314, 316, 318, 320, 322, 324, 326, 330, 332, 334, 336, 342, and 344 may be stored in memory 348 of SOM 346, the communication interfaces themselves, and/or dedicated controllers coupled to the communication interfaces. In addition or alternatively, communication over various protocols may also be carried out by application-specific integrated circuits (ASICs), field-programmable gate arrays (FPGAs), or other integrated circuits in an apparatus in accordance with the present invention. In the exemplary embodiment, the appropriate protocol for communication is automatically identified and used by apparatus 300 when a communication device is communicatively coupled to apparatus 300. Apparatus 300 and other embodiments of apparatuses in accordance with the present invention implement the entire stack of each communication protocol, from the lowest layer to the highest layer. Furthermore, apparatus 300 and other embodiments of apparatuses in accordance with the present invention convert communications between protocols associated with the various communication interfaces, thereby enabling communication across and among communication devices that communicate using different protocols.

Those skilled in the art will appreciate that while two devices may be configured to communicate using different protocols, such as differing versions of USB, some commonality exists between the protocols such that, for example, a USB 1.0 communication device may still communicate with a USB 2.0 device. In other words, the different versions of USB in the above example can communicate with each other without translation between the protocols. By contrast, other protocols are not only different, but unable to communicate with one another without translation between the two protocols. For example, a device configured to communicate pursuant to MIL-STD-1553 is unable to communicate with a device configured to communicate using a Bluetooth connection. Apparatuses in accordance with the present invention enable communication among at least three devices that would otherwise be unable to communicate with one another device without translation between the protocols of the devices.

Apparatus 300 includes an external power interface 352. External power interface 352 is coupled to power conditioner 354 which conditions power from an external source. In the exemplary embodiment, power conditioner 354 is compliant with power conditioning standards MIL-STD-704 and MIL-STD-1275. Power conditioner 354 is coupled to a power block 356, which coupled to battery 358 and power line 390. Power block 356 is responsible for distributing and receiving power from battery 358 and distributing power to the components of apparatus 300 through power line 390. Battery 358 provides power to apparatus 300 when no external source of power is providing power through external power interface 352. In the exemplary embodiment, battery 358 is a lithium-ion polymer battery and is housed within apparatus 300. In alternative embodiments, battery 358 stores energy with materials and chemicals other than lithium polymers. In further embodiments, battery 358 may be external to apparatus 300 or housed within apparatus 300 and readily accessible and replaceable through a removable section in the housing of apparatus 300.

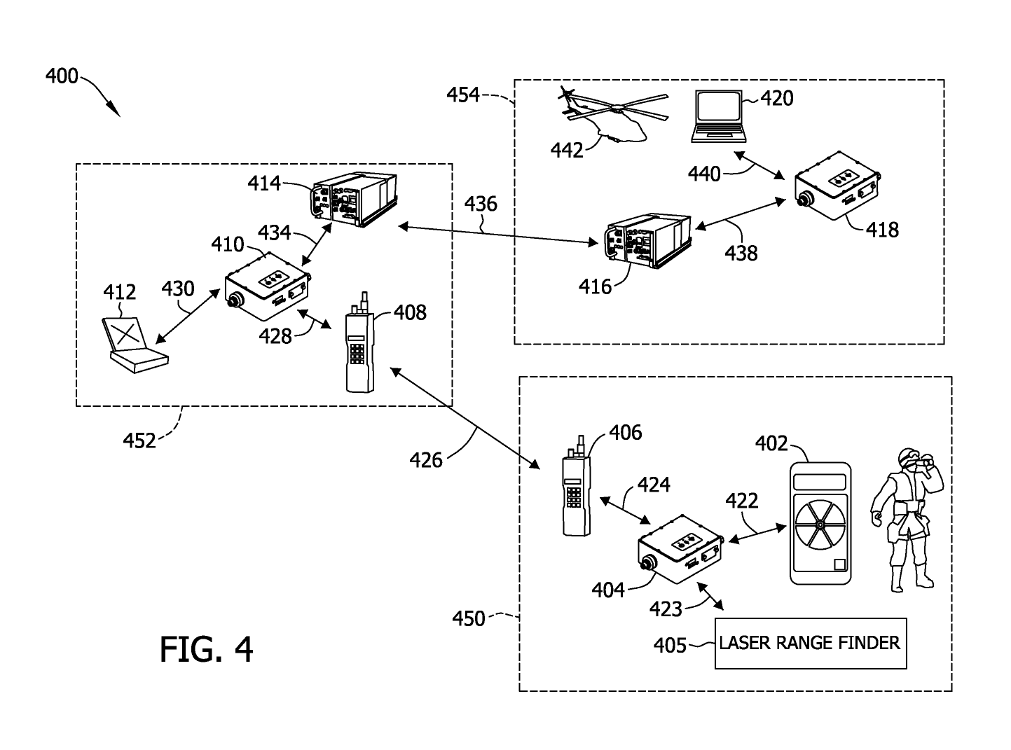

FIG. 4 is a diagram of a first system 400 of apparatuses and communication devices in accordance with an exemplary embodiment of the present invention. A communication device 402 is in communication with apparatus 404 using a short range wireless connection 422. In the exemplary embodiment, communication device 402 is a smart phone. In other embodiments, communication device 402 may be, for example, a personal digital assistant, a tablet computer, notebook computer or other mobile computing device. In the exemplary embodiment, communication device 402 includes a touch screen that functions to display information and receive input through touch. In some embodiments, the communication device 402 displays a map. In further embodiments, the communication device 402 is configured to designate a geographic location. For example, a location on a map displayed on communication device 402 may be designated by an operator of the communication device 402. In the exemplary embodiment, the short range wireless connection 422 is a Bluetooth connection. Simultaneously, apparatus 404 is in communication with communication device 406. In FIG. 4, communication device 406 is a PRC-152 radio. Communication device 406 and apparatus 404 are in communication using a MIL-STD-188-184 connection 424. MIL-STD-188-184 is different than, and unable to communicate with, Bluetooth without translation between the two protocols. Apparatus 404 is also in communication with communication device 405 using an RS-232 connection 423. Communication device 405 is a laser range finder. Laser range finder 405 is unable to communicate with communication devices 402 and 406 without translation between the protocols of the respective connections 422, 423, 424. Communication device 406 is in communication with communication device 408, which is also a PRC-152 radio, using a long range wireless connection 426. Data transmitted across long range wireless connection 426 is transmitted using MIL-STD-188-220 over VHF (very high frequency). As known in the art, MIL-STD-188-220 over VHF is unable to communicate directly with, for example, Bluetooth. Rather, translation is required between the protocols.

Communication device 408 is in communication with apparatus 410 using a MIL-STD-188-184 connection 428. Apparatus 410 is also in communication with communication device 412 using an IEEE 802.11n connection 430. Communication device 412 is, for example, a notebook computer or desktop computer. Apparatus 410 is also in communication with communication device 414 using an Ethernet connection 434. Communication device 414 is a MIDS terminal Communication device 414 is in communication with communication device 416 (also a MIDS terminal) using Link 16 over UHF (ultra high frequency) connection 436. As is known in the art, Link 16 is a tactical data link (TDL) protocol. Link 16 over UHF is unable to communicate directly with other protocols, for example Ethernet as used in connection 428, or IEEE 802.11, as used in connection 430, without translation. Communication device 416 is in communication with apparatus 418 using a MIL-STD-1553 connection 438. Apparatus 418 is in communication with a communication device 420 using an Ethernet connection. Communication device 420 is an onboard computer housed within helicopter 442.

In the system 400 of FIG. 4, communication devices 402 and 406, as well as apparatus 404 form a group 450 associated with a “requester”. Communication devices 408, 412, and 414, as well as apparatus 410 form a group 452 associated with an “approver”. Communication devices 416 and 420, as well as apparatus 418 form a group 454 associated with a “responder”. That is, the items in this group 454 are associated with an entity that responds to an instruction to provide assistance at a location. In the exemplary embodiment, communication device 402 sends a request for assistance through apparatus 404, communication devices 406 and 408, and apparatus 410 to communication device 412. In response, communication device 412 sends an instruction to provide assistance though apparatus 410, communication device 414, communication device 416 and apparatus 418 to communication device 420. Again, communication device 420 is an onboard computer housed within helicopter 442.

In the exemplary embodiment, the request for assistance and the instruction to provide assistance include a location of where assistance is to be provided. For example, communication device 402 may include a GPS antenna and receiver, and may include the location of the communication device 402 in the request for assistance. Alternatively, and given that apparatus 404 and communication device 402 are in close proximity to each other, apparatus 404 may utilize an internal GPS antenna and receiver, or an externally-connected GPS antenna and receiver to obtain a location to include in the request for assistance. In other embodiments, communication device 402 and/or apparatus 404 may be configured to obtain a location from the GPS antenna and receiver and offset the location by a distance determined by laser range finder 405.

In the exemplary embodiment, communication device 402 and communication device 412 remain in communication after the request for assistance is sent and received. Likewise, communication device 412 and 420 remain in communication after the instruction to provide assistance is sent and received. In the exemplary embodiment, communication device 412 receives repeated messages from communication device 420 with updates as to the location of communication device 420. That is, communication device 420 includes or is connected to a GPS antenna and receiver. In other embodiments, apparatus 418 includes an internal GPS antenna and receiver or is connected to an external GPS antenna and receiver, and includes its location in periodic update messages to communication device 412. Communication device 412 sends corresponding messages to communication device 402 to provide the location of communication device 420 and/or estimated time of arrival of the requested assistance. The location of communication device 420 and/or estimated time of arrival information may be displayed by communication device 402. In alternative embodiments, there are multiple responder groups and multiple requester groups. In further embodiments, there are also multiple approver groups. In further embodiments, a request for assistance may also include an indication of the type of assistance requested. In embodiments where multiple responder groups are available, a responder group may be selected by an approver group based on the type of assistance requested.

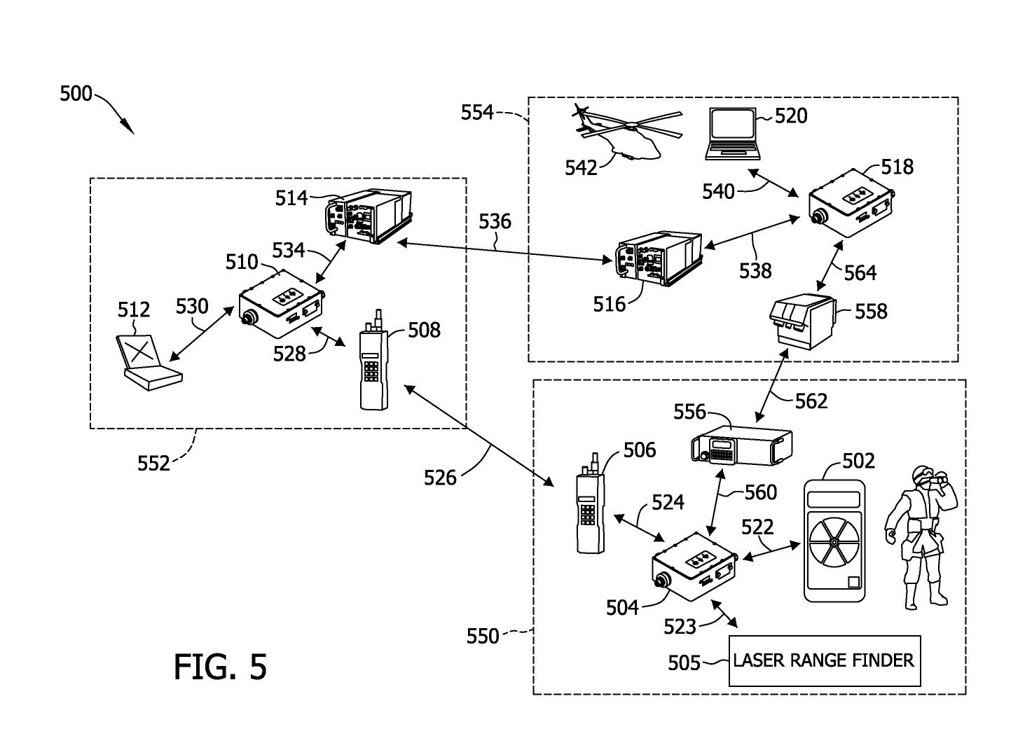

FIG. 5 is a diagram of a second system 500 of apparatuses and communication devices in accordance with another embodiment of the present invention. Apparatuses 504, 510 and 518 are similar to apparatuses 404, 410, and 418 of FIG. 4. Further, communication devices 502, 505, 506, 508, 512, 514, 516, and 520 are similar to communication devices 402, 405, 406, 408, 412, 414, 416, and 420 of FIG. 4. Additionally, helicopter 542 is similar to helicopter 442 of FIG. 4. Likewise, connections 522, 523, 524, 526, 528, 530, 534, 536, 538, and 540 are similar to connections 422, 424, 426, 428, 430, 434, 436, 438, and 440 of FIG. 4. Groups 550, 552, and 554 are similar to groups 450, 452, and 454 of FIG. 4. A difference from the system of FIG. 4, however, is that apparatus 504 is in communication with communication device 556. Communication device 556 is a PRC-117F radio. Apparatus 504 is in communication with communication device 556 using a MIL-STD-188-184 connection 560. Communication device 556 is in communication with communication device 558, which is a MIDS terminal, using a Link 16 over UHF connection 562. Communication device 558 is in communication with apparatus 518 using an Ethernet connection 564.

In system 500, once communication device 512 receives a request for assistance from communication device 502 and sends and instruction to communication device 520 to provide assistance at the location of communication device 502, communication device 512 also sends an instruction to both communication device 502 and 520 to establish communication directly between each other. The communication between communication device 502 and communication device 520 may then exist exclusively of any communication with communication device 512, or each of communication devices 502 and 520 may simultaneously maintain communication with communication device 512. For example, direct communication may allow communication devices 502 and 520 to send update messages to each other more efficiently than if the update messages are mediated by communication device 512. However, maintaining a communication with communication device 512 allows communication devices 502 and 520 to keep communication device 512 apprised of the progress of providing assistance, and to leave open the possibility of communication device 502 requesting additional assistance and/or communication device 520 receiving instructions to provide assistance at additional locations.

This written description uses examples to disclose the invention, including the best mode, and also to enable any person skilled in the art to practice the invention, including making and using any devices or systems and performing any incorporated methods. The communication protocols discussed above are exemplary only, and those skilled in the art will appreciate that other protocols, including CDMA, GSM, GPRS, EDGE, EV-DO, and WIMAX, may be used instead or in addition to the protocols discussed above. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus for enabling communication among a plurality of different communication devices, said apparatus comprising:
a processor configured to:
receive a first message from a first communication device using a first communication protocol;
insert a geographic location within the first message; and
transmit the first message to a second communication device using a second communication protocol that is different from the first communication protocol.

2. The apparatus in accordance with claim 1, wherein said processor is further configured to:
receive a second message from the second communication device using the second communication protocol; and
transmit the second message to the first communication device using the first protocol.

3. The apparatus in accordance with claim 1, wherein said processor is further configured to receive the first message using a wireless communication protocol.

4. The apparatus in accordance with claim 1, wherein at least the first message is encrypted.

5. The apparatus in accordance with claim 2, wherein at least the second message is encrypted.

6. The apparatus in accordance with claim 1, wherein said processor is further configured to convert a video from a first format to a second format.

7. The apparatus in accordance with claim 1, further comprising a switch coupled to a first global positioning system (GPS) device and a second GPS device and said processor is further configured to receive the geographic location from one of the first GPS device and the second GPS device.

8. The apparatus in accordance with claim 7, wherein at least one of the first message and the second message includes a request for assistance at the geographic location or a command to provide assistance at the geographic location.

9. The apparatus in accordance with claim 7, wherein said processor is additionally configured to:
determine that one of the first GPS device and the second GPS device is malfunctioning and that the other of the first GPS device and the second GPS device is properly functioning; and
receive the geographic location from the properly functioning GPS device.

10. The apparatus in accordance with claim 1, further comprising an internal memory device and an external memory interface configured to receive an external memory module and said processor is further configured to copy processor-executable instructions for communicating using at least a third communication protocol from the external memory module to said internal memory device.

11. A system for enabling communication among a plurality of different communication devices, said system comprising:
a first communication device configured to communicate using a first communication protocol;
a second communication device configured to communicate using a second communication protocol;
a third communication device configured to communicate using a third communication protocol;
a fourth communication device configured to communicate using a fourth communication protocol;
a fifth communication device configured to communicate using a fifth communication protocol;
a sixth communication device configured to communicate using a sixth communication protocol;
a seventh communication device configured to communicate using a seventh communication protocol;
a first apparatus communicatively coupled to said first communication device and said second communication device, said first apparatus being configured to translate between the first communication protocol and the second communication protocol;
a second apparatus communicatively coupled to said third communication device, said fourth communication device, and said fifth communication device, said second apparatus being configured to translate between the third communication protocol and the fourth communication protocol and between the fourth communication protocol and the fifth communication protocol;
a third apparatus communicatively coupled to said sixth communication device and said seventh communication device, said third apparatus being configured to translate between the sixth communication protocol and the seventh communication protocol;
wherein said first communication device is configured to transmit a first message to said first apparatus, said first apparatus is configured to receive the first message from the first communication device using the first communication protocol, insert a geographic location within the first message, and transmit the first message to said second communication device using the second communication protocol that is different from the first communication protocol, said second communication device is configured to transmit the first message to said third communication device, said third communication device is configured to transmit the first message to said second apparatus, and said second apparatus is configured to transmit the first message to said fourth communication device, said fourth communication device is configured to transmit a second message to said second apparatus, said second apparatus is configured to transmit the second message to said fifth communication device, said fifth communication device is configured to transmit the second message to said sixth communication device, said sixth communication device is configured to transmit the second message to said third apparatus, and said third apparatus is configured to transmit the second message to said seventh communication device.

12. The system of claim 11, wherein said first apparatus includes a switch coupled to a first global positioning system (GPS) device and a second GPS device and said apparatus is further configured to receive the geographic location from one of the first GPS device and the second GPS device.

13. The system of claim 12, wherein said first apparatus is further configured to:
determine that one of the first GPS device and the second GPS device is malfunctioning and that the other of the first GPS device and the second GPS device is properly functioning; and
receive the geographic location from the properly functioning GPS device.

14. The system of claim 12, wherein the second message includes a command to provide assistance at the geographic location.

15. The system of claim 16, wherein said first apparatus is further configured to receive a distance from the laser range finder and offset the geographic location by the distance before inserting the geographic location within the first message.

16. The system of claim 11, wherein said first apparatus is communicatively coupled to a laser range finder.

17. The system of claim 11, wherein said fourth communication device is further configured to transmit periodic updates of a position of the seventh communication device to said first communication device.

18. The system of claim 11, wherein said fourth communication device is further configured to transmit a time of arrival of said seventh communication device to said first communication device.

19. The system of claim 11, wherein said first communication device is further configured to display a map.

20. The system of claim 18, wherein said first communication device is further configured to display the position and the time of arrival.

21. A method for enabling communication among a plurality of different communication devices using an apparatus having a processor coupled to a memory, said method comprising:
receiving, by the apparatus, a first message from a first communication device using a first communication protocol;
inserting, by the apparatus, a geographic location within the first message; and
transmitting, by the apparatus, the first message to a second communication device using a second communication protocol that is different from the first communication protocol.

22. The method in accordance with claim 21, further comprising:
receiving, by the apparatus, a second message from the second communication device using the second communication protocol; and
transmitting, by the apparatus, the second message to the first communication device using the first communication protocol.

23. The method in accordance with claim 21, wherein receiving the first message further comprises receiving the first message using a wireless communication protocol.

24. The method in accordance with claim 21, wherein at least the first message is encrypted.

25. The method in accordance with claim 22, wherein at least the second message is encrypted.

26. The method in accordance with claim 21, further comprising converting, by the apparatus, a video from a first format to a second format.

27. The method in accordance with claim 21, wherein the apparatus includes a switch coupled to a first global positioning system (GPS) device and a second GPS device and said method further comprises receiving, by the apparatus, the geographic location from one of the first GPS device and the second GPS device.

28. The method in accordance with claim 21, wherein transmitting the first message further comprises transmitting the first message that includes a request for assistance or a command to provide assistance at the geographic location.

29. The method in accordance with claim 27, further comprising:
determining that one of the first GPS device and the second GPS device is malfunctioning and that the other of the first GPS device and the second GPS device is properly functioning; and
receiving the geographic location from the properly functioning GPS device.

30. The method in accordance with claim 21, wherein the memory is an internal memory device and the apparatus additionally includes an external memory interface configured to receive an external memory module, said method further comprising using the external memory interface to copy processor-executable instructions for communicating using at least a third communication protocol from the external memory module to the internal memory device.
